(19) United States
(12) Patent Application Publication
(10) Pub. No.: US 2026/0039717 A1
(43) Pub. Date: Feb. 5, 2026

(54) ADAPTIVE METHODS FOR ROUTING DATA IN A SECURE STORAGE NETWORK

(71) Applicant: Veeva Systems Inc., Pleasanton, CA (US)

(72) Inventors: Julia Ran Deng, Brooklyn, NY (US); Florian Emmanuel Bernard Gilbert Letourneux, Rennes (FR); Jared Ross Katz, San Francisco, CA (US); Marius K. Mortensen, Burlington (CA); Carlos Martelo, Miami, FL (US); Seth Taylor, Bend, OR (US); Eric Emerton, Cary, NC (US); Michael Lucas Carbone, Toronto (CA); Steven Snow, Philadelphia, PA (US)

(21) Appl. No.: 18/789,218

(22) Filed: Jul. 30, 2024

(51) Int. Cl. H04L 67/125; H04L 67/1097; H04L 67/63

(52) U.S. Cl. CPC H04L 67/125; H04L 67/1097; H04L 67/63

(57) ABSTRACT

This disclosure is directed to a method comprising: initiating a first application, a second application, and a third application, which are associated with a secure computing network; routing a first computing input, a second computing input, and third computing input, respectively, to the first application, the second application and the third application; executing, using the first application and based on the first computing input, a first computing operation and thereby generating a first local computing result; executing, using the second application, based on the second computing input, a second computing operation and thereby generating a second local computing result; and executing, using the third application, based on the third computing input, a third computing operation and thereby generating a third local computing result. The method also includes leveraging the first local computing result, the second local computing result, and third local computing result to generate network resolution data.

### TECHNICAL FIELD

This disclosure is directed to routing data in a secure storage network and thereby generate resolution data.

### BACKGROUND

In complex secure storage networks having a plurality of distinct applications which individually or in aggregate, operate on data inputs, there is a need to link computing outputs from said plurality of applications to develop holistic strategies for managing and/or resolving identified events, flagged issues, or some other determined problem data associated with the data inputs.

### SUMMARY

This disclosure is directed to methods, systems, and computer program products for routing data in a computing network such as a secure storage network. According to an embodiment, a method for routing data in a secure storage network comprises: initiating a first application on the computing network configured to generate a first computing result; initiating a second application on the computing network configured to generate a second computing result, wherein the second application is different from the first application; and initiating a third application on the computing network configured to generate a third computing result, wherein the third application is different from both the first application and the second application.

The method also comprises: routing, at a first time, a first computing input to the first application based on computing assessment data or a first parameter comprised in or associated with the first computing input, the computing assessment data being different from the first parameter; routing, at a second time different from the first time, a second computing input to the second application based on computing inquiry data or a second parameter comprised in or associated with the second computing input, the computing inquiry data being different from all of the second parameter, the first parameter, and the computing assessment data; and routing, at a third time different from both the first time and the second time, a third computing input to the third application based on computing event data or a third parameter, the computing event data being different from the third parameter, the second parameter, the computing inquiry data, the first parameter, and the computing assessment data.

According to one embodiment, the method comprises: executing, using the first application and based on the first computing input, a first computing operation and thereby generating the first computing result; executing, using the second application, based on the second computing input, a second computing operation and thereby generating the second computing result; and executing, using the third application, based on the third computing input, a third computing operation and thereby generating the third computing result.

In some embodiments, the method comprises: generating, based on the first computing result, the second computing result, and the third computing result, combinatorial network data; and formatting the combinatorial network data, thereby resulting in formatted combinatorial network data.

In addition, the method comprises generating or determining, based on the formatted combinatorial network data: first source data associated with the first computing input, second source data associated with the second computing input, and third source data associated with the third computing input; and sequence data showing an order of receipt of the first computing input, the second computing input, and the third computing input. The method can also comprise generating or determining, based on the formatted combinatorial network data, impact data associated with a relationship among the first computing result, the second computing result, and the third computing result.

Moreover, the method comprises resolving, based on the first source data, the second source data, the third source data, the sequence data, the impact data, the computing assessment data, the computing inquiry data, and the computing event data, thereby resulting in network resolution data.

In another embodiment, a system and a computer program product can include or execute the method described above. These and other implementations may each optionally include one or more of the following features.

The first computing input or the second computing input may be derived from at least one communication channel comprising at least one of: a telephonic communication channel; a web application communication channel; an email communication channel; a video communication channel; a mobile messaging communication channel; a social media communication channel; or a secure communication channel associated with the secure storage network.

In some embodiments, an electronic confirmation is transmitted to a first computing device via a first one of the at least one communication channel. Furthermore, the network resolution data may also be transmitted to a second computing device via one of the at least one communication channel.

According to some embodiments, the first computing device is associated with a first geographical location and the second computing device is associated with a second geographical location.

It is appreciated that the first application or the second application or the third application comprises one of: an assessment computing application configured to monitor, regulate, or transmit deviation data associated with a first record or a second record; an inquiries computing application configured to parse or analyze data requests associated with the first computing input, the second computing input, or the third computing input; an event processing computing application configured to analyze the first computing input, the second computing input, or the third computing input to determine a first detected event, a second detected event, or a third detected event, respectively; and an electronic data capture (EDC) application configured to generate a first record, a second record, or a third record associated with the first computing input, the second computing input, or the third computing input, respectively.

According to one embodiment, the first application comprises an assessment computing application associated with a first data repository of the secure storage network such that the first data repository stores first impact assessment data associated with the first computing result. Furthermore, the second application can comprise an assessment computing application associated with a second data repository of the secure storage network such that the second data repository stores second impact assessment data associated with the second computing result. In addition, the third application can comprise an inquiry computing application associated with a third data repository of the secure storage network such that the third data repository stores third impact assessment data associated with the third computing result. It is appreciated that the first computing result, the second computing result, and the third computing result, respectively, can comprise the first impact assessment data, the second impact assessment data, and the third impact assessment data. It is further appreciated that the first impact assessment data, the second impact assessment data, and the third impact assessment data can be related or otherwise linked, based on integration point configuration data associated with the first repository, the second repository, and the third repository, to generate the combinatorial network data.

In some implementations, one of the third computing input or a fourth computing input is simultaneously routed to two or more distinct applications. In addition, the two or more distinct applications are configured to execute multiple computing operations on one of the third computing input or the fourth computing input.

According to one embodiment, one or more of the first computing input or the second computing input is digitally converted or transformed into a first record or a second record, respectively, prior to executing the first computing operation or the second computing operation, respectively. Moreover, a script or a configurable web form may be used for transforming the first computing input or the second computing input into the first record or the second record, respectively.

In some cases, the above method further comprises linking, using the one or more data engines, first event data associated with the first computing input to second event data associated with the second computing input. The one or more data engines may be further used to generate the network resolution data based on events (e.g., event data) detected in at least one of the first computing input, the second computing input, or the third computing input. According to one embodiment, a first detected event comprised in the events detected indicates a defect associated with a configurable data object while a second detected event comprised in the detected events indicates outcome data associated with the configurable data object.

It is appreciated that the computing network referenced above can comprise a secure storage network. It is further appreciated that the formatted combinatorial network data can indicate a global computing output for the secure storage network. Moreover, the global computing output can comprise data elements associated with the first computing result, the second computing result, and the third computing result. In addition, the global computing output can provide a holistic indication of a detected or logged event associated with the secure storage network.

According to some embodiments, the relationship among the first computing result, the second computing result, and the third computing result comprises one of: a causal relationship among the first computing result, the second computing result, and the third computing result; or a dependence relationship among the first computing result, the second computing result, and the third computing result.

In some embodiments, resolving, based on the first source data, the second source data, the third source data, the sequence data, the impact data, the computing assessment data, the computing inquiry data, and the computing event data, comprises: analyzing data elements comprised in the first source data, the second source data, the third source data, the sequence data, and the impact data, to determine one or more record links between the first source data, the second source data, the third source data, the sequence data, and the impact data; establishing, based on the one or more record links, one or more electronic connections between the data elements comprised in the first source data, the second source data, the third source data, the sequence data, and the impact data; and generating, based on the one or more electronic connections, the network resolution data.

It is appreciated that the first computing operation can be associated with a control event while the second computing operation can be associated with a bioreaction event. It is further appreciated that the third computing operation can be associated with a diagnostic event.

According to one embodiment, the combinatorial network data is generated by selectively merging or combining data elements comprised in the first computing result, the second computing result, and the third computing result.

In some cases, the first parameter comprises a first record type associated with the computing assessment data while the second parameter comprises a second record type associated with the computing inquiry data. It is appreciated that the third parameter can comprise a third record type associated with the computing event data.

According to one embodiment, the computing assessment data indicates a first log of an assessment of a configurable data object while the computing inquiry data indicates a second log of an inquiry associated with applying or using the configurable data object. It is appreciated that the computing event data can indicate a third log of an adverse event associated with applying or using the configurable data object.

### BRIEF DESCRIPTION OF THE DRAWINGS

The disclosure is illustrated by way of example, and not by way of limitation in the figures of the accompanying drawings in which like reference numerals are used to refer to similar elements. It is appreciated that various features may not be drawn to scale and the dimensions of various features may be arbitrarily increased or reduced for clarity of discussion. Further, some components may be omitted in certain figures for clarity of discussion.

FIG. 1A illustrates an exemplary secure storage network within which the present technology may be implemented, according to some embodiments of this disclosure.

FIG. 1B illustrates an example block diagram of a computing device within which one or more systems or devices of FIG. 1A can be implemented, according to some embodiments of this disclosure.

FIG. 2 illustrates an example high level block diagram of the data management system of FIG. 1A, according to some embodiments of this disclosure.

FIG. 3A shows a first exemplary interconnection of a plurality of applications associated with the secure storage network 100 FIG. 1A, according to some embodiments.

FIG. 3B shows a second exemplary interconnection of a plurality of applications associated with the secure storage network 100 FIG. 1A, according to some embodiments.

FIG. 3C shows a third exemplary interconnection of a plurality of applications associated with the secure storage network 100 FIG. 1A, according to some embodiments.

FIGS. 4A and 4B show an exemplary workflow for routing a computing input within a computing network and generating network resolution data, according to some embodiments of this disclosure.

Although similar reference numbers for the foregoing drawings may be used to refer to similar elements for convenience, it is appreciated that each of the various exemplary embodiments may be considered to be distinct variations. As used in this disclosure, the terms “embodiment,” “example embodiment,” “exemplary embodiment,” “implementation,” and the like do not necessarily refer to a single embodiment, although it may, and various example embodiments may be readily combined and interchanged, without departing from the scope or spirit of the present disclosure. Furthermore, the terminology used herein is for the purpose of describing example embodiments only, and are not intended to be limitations. In this respect, as used herein, the term “in” may include “in” and “on,” and the terms “a,” “an” and “the” may include singular and plural references. Furthermore, as used herein, the term “by” may also mean “from,” depending on the context. Furthermore, as used herein, the term “if” may also mean “when” or “upon,” depending on the context. Furthermore, as used herein, the words “and/or” may refer to and encompass any and all possible combinations of one or more of the associated listed items.

### DETAILED DESCRIPTION

Reference will now be made to various embodiments, examples of which are illustrated in the accompanying drawings and figures. In the following detailed description, numerous specific details are set forth in order to provide a thorough understanding of this disclosure. However, it will be apparent to one of ordinary skill in the art that the disclosure may be practiced without these specific details. In some instances, well-known methods, processes, components, systems, and networks have not been described in detail so as not to unnecessarily obscure aspects of the disclosed embodiments.

### Network Environment

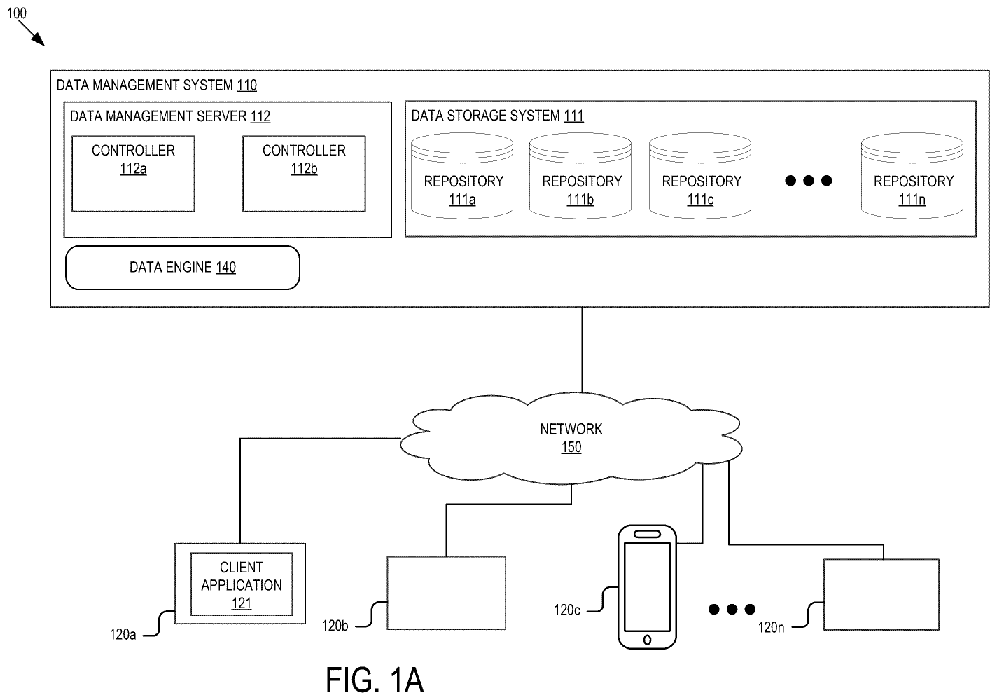

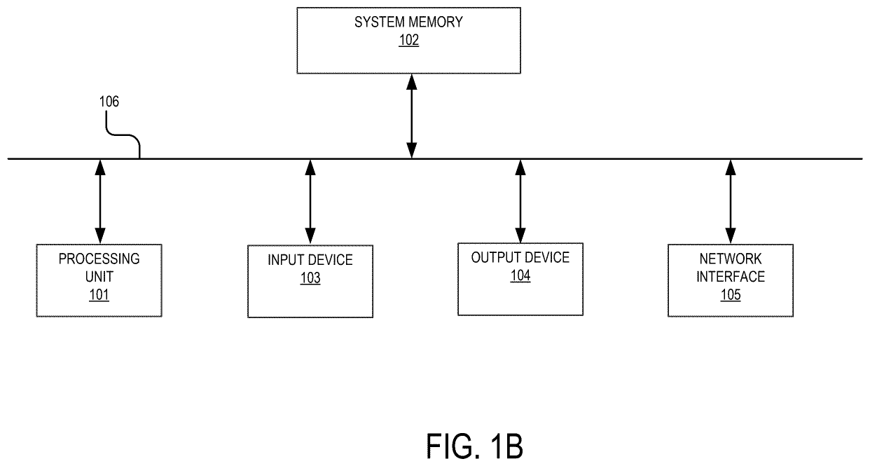

FIG. 1A illustrates an exemplary secure storage network 100 within which the present technology may be implemented. As shown, the secure storage network 100 may include a data management system 110 (also referred to as a secure storage system 110 elsewhere herein), and a plurality of user computing devices 120a, 120b, . . . 120n coupled to each other via a network 150.

The data management system 110 may include a data storage system 111 and a data management server 112. The data storage system 111 may have one or more secure repositories 111a, 111b, 111c, . . . 111n. Each of the one or more secure repositories 111a, 111b, 111c, . . . 111n may comprise two or more secure storage structures configured to store, at least index data and/or file data, and/or record data as the case may require. According to one embodiment, the index data and/or file data, and/or record data may be associated with medical facility, a research facility, a governmental agency, an educational institution, etc. In some cases, the data storage system 111 comprises secure data structures and/or computing storage structures that securely store data indices, files associated with said data indices, and/or records associated with said data indices.

The network 150 may include one or more types of communication networks such as a local area network (“LAN”), a wide area network (“WAN”), an intra-network, an inter-network (e.g., the Internet), a telecommunication network, and peer-to-peer networks (e.g., ad hoc peer-to-peer networks), which may be wired or wireless.

The user computing devices 120a, . . . 120n may be any machine or system that is used by a user to access the data management system 110 via the network 150, and may comprise computing devices including laptop computers, desktop computers, mobile phones, smart phones, tablet computers, and netbooks. A client application 121 (e.g., a secure interface) associated with the data management system 110 may be run from a user computing device (e.g., 120a) to securely access data in the data management system 110 via the network 150.

The data storage system 111 may store data that client applications (e.g., client application 121) in user computing devices 120a . . . 120n may access. Furthermore, the data storage system 111 may comprise any commercially available storage devices.

According to one embodiment, each content repository (e.g., 111a, 111b, 111c, . . . or 111n) may store one or more data categories such that one or more users may be provided access to the one or more data categories based on context data associated with the one or more users and/or context data associated with the one or more data categories.

It is appreciated that the disclosed content repositories 111a, 111b, 111c, . . . 111n may comprise separate logic sections in the same storage device. According to one embodiment, content data stored in the content repositories 111a, 111b, 111c, . . . 111n may comprise controlled content stored in specialized databases including at least one source of truth database within said repositories such that specific users and/or specific computing devices may be provided credential access to said repositories based on one or more profiles of the specific users and/or specific devices previously stored or otherwise associated with the data management system 110.

According to one embodiment, each of the content repositories 111a, 111b, 111c, . . . 111n can be implemented as one or more computer-readable or machine-readable storage media that are non-transitory. In some embodiments, the content repositories 111a, 111b, 111c, . . . 111n may be distributed within and/or across multiple internal and/or external enclosures of a computing system and/or additional computing systems. Furthermore, each of the content repositories 111a, 111b, 111c, . . . 111n may comprise one or more similar or dissimilar forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks; optical media such as compact disks (CDs) or digital video disks (DVDs), BluRays or other types of optical media; or other types of storage devices.

The data management server 112 may comprise a remote computer system accessible over a remote or local network, such as the network 150. The data management server 112 may store a data management controller 112a and a data collection controller 112b for controlling management and collection of the data. The data management server 112 could be any commercially available computing devices. Although only one server is shown, it is appreciated that the data management system 110 may have a plurality of servers such that the controllers 112a and 112b may be in separate servers. A client application (e.g., client application 121) may be active on one or more user computing devices 120a, . . . , 120n. The corresponding server application may be active on the data management server 112. The client application and the corresponding server application may communicate with each other over the network 150 and thereby provide distributed functionality and allow multiple client applications to take advantage of the information-gathering capabilities of the data management system 110.

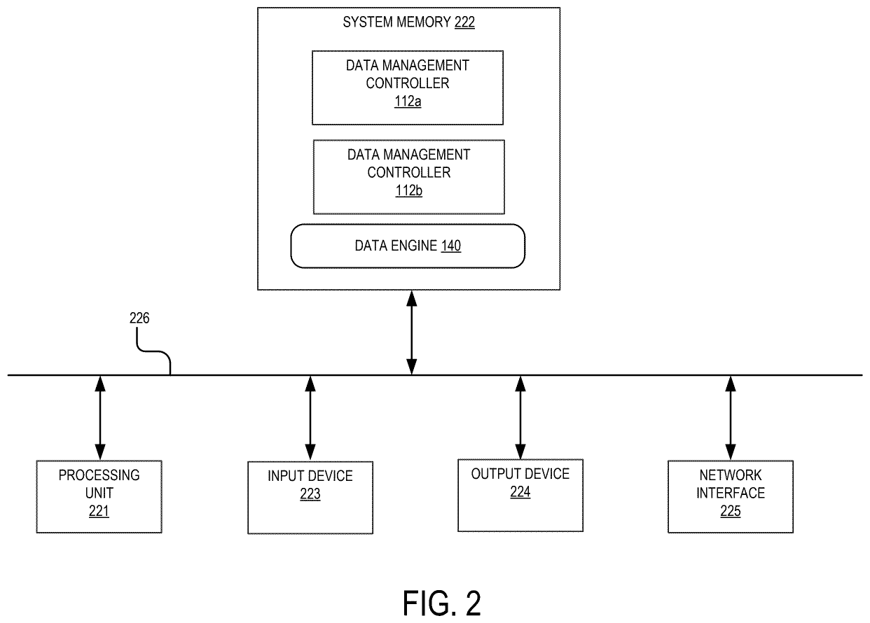

The data engine 140 shown within the data management system 110 may include instructions stored in a system memory (e.g., memory 222 of FIG. 2) that are executed by one or more computing device processors (e.g., processing unit 221 of FIG. 2). The instructions may include various operations or processes discussed below in association with, for example, one or more task protocols, and/or one or more data routing computing operations, and/or one or more data correlation or data relation computing operations.

In one embodiment, the secure storage network 100 may be used for collecting and managing data (e.g., index data, file data, record data, file or record data associated with a trial, file or record data associated with a research, medical file or record data, etc.). For example, a first repository (e.g., repository 1l1a) of the secure storage network 100 may store electronic records or electronic files or index data as the case may require. In some cases, the electronic records comprise electronic data capture (EDC) data and/or trial source data (e.g., associated with a subject), and/or medical inquiry data, and/or quality control data, and/or safety data, etc. It is appreciated that a trial as described in this disclosure may refer to a clinical trial.

The data management system 110 may have: one or more interfaces for receiving the plurality of data described herein; database or query mechanisms for operating on the plurality of data; and one or more reporting tools for analysis of the plurality of data.

Furthermore, each of the content repositories 111a, 111b, 111c, . . . or 111n may be used by a plurality of sites (e.g., a hospital site, a school site, a research site, a pharmaceutical company site, etc.) to store the plurality of data provided in this disclosure. In one embodiment, the plurality of data comprises source data (e.g., vital statistics data such as blood pressure values, research results values, chemical analysis values, biographic data, bibliographic data, demographic data, test data, etc.) which may be converted to EDC data automatically, and then stored in one or more of the content repositories 111a, 111b, 111c, . . . or 111n. It is appreciated that the EDC data stored in the various content repositories 111a, 111b, 111c, . . . or 111n may be synchronized to ensure that data inconsistencies do not creep into any of the content repositories 111a, 111b, 111c, . . . or 111n. It is further appreciated that each of the content repositories 111a, 111b, 111c, . . . or 111n may have two or more data storage structures.

In one embodiment, the data management system 110 may comprise a multi-tenant system where various elements of hardware and software are shared by one or more users. For instance, the data management server 110 may simultaneously and securely process requests from a plurality of users, and the data storage system 111 may securely store controlled or secure content for the plurality of users.

In one embodiment, the data management system 110 may run on a cloud computing platform. Users of said cloud computing platform can access the controlled content comprised in the cloud computing platform independently by using, for example, a virtual machine image, or acquiring access to a service maintained by a cloud database provider associated with the secure storage network 100. In one embodiment, the data management system 110 may be provided as Software as a Service (“SaaS”) to allow users to access the data management system 110 with, for example, a thin client.

FIG. 1B illustrates an example block diagram of a computing device which can be used as the computing devices 120a, . . . , 120n, and the data management system 110 of FIG. 1A. The illustrated computing device is only one example of a suitable computing environment and is not intended to suggest any limitation as to scope of use or functionality. The computing device of FIG. 1B may include a processing unit 101, a system memory 102, an input device 103, an output device 104, a network interface 105, and a system bus 106 that couples these components to each other.

The processing unit 101 may be configured to execute computer instructions or computing operations that are stored in a computer-readable medium, for example, the system memory 102. The processing unit 101 may comprise a central processing unit (CPU).

The system memory 102 can include a variety of computer readable media which may be any available media accessible by the processing unit 101. For instance, the system memory 102 may include computer storage media in the form of volatile and/or non-volatile memory such as read only memory (ROM) and/or random-access memory (RAM). By way of example, but not limitation, the system memory 102 may store instructions and data including an operating system, program sub-systems, various application programs, and program data.

A user can enter computing commands and/or information to the computing device of FIG. 1B through the input device 103. The input device 103 may comprise a keyboard, a touchscreen input device, a touch pad, a mouse, a microphone, and/or an electronic pen and/or some other input computing device.

The computing device of FIG. 1B may provide output data via the output device 104 which may comprise a monitor, a display device (e.g., a display screen of a tablet, cell phone, etc.), a speaker, a printer, or some other output computing device.

The computing device of FIG. 1B, through the network interface 105, may operate in a networked or distributed environment using logical connections to one or more other computing devices, which may be a personal computer (PC), a server, a router, a network PC, a peer device, a smart phone, or any other media consumption or transmission computing device, and may include any or all of the elements described above. The logical connections may include a network (e.g., the network 150) and/or buses. The network interface 105 may be configured to allow the computing device of FIG. 1B to transmit and receive data in a network, for example, the network 150. The network interface 105 may include one or more network interface cards (NICs). It is appreciated that the computing device of FIG. 1B could comprise a stationary computing device or a mobile computing device.

FIG. 2 illustrates an example high level block diagram of the data management server 112 according to one embodiment of the present disclosure. The data management server 112 may be implemented by the computing device such as the computing device of FIG. 1B, and may have a processing unit 221, a system memory 222, an input device 223, an output device 224, and a network interface 225, coupled to each other via a system bus 226.

The system memory 222 may comprise data management controllers 112a and 112b. In one embodiment, the data management controllers 112a and 112b may be comprised in one or more applications including a web application or a Java application. In addition, the data management controllers 112a and 112b may be configured to receive and/or store the plurality of data disclosed.

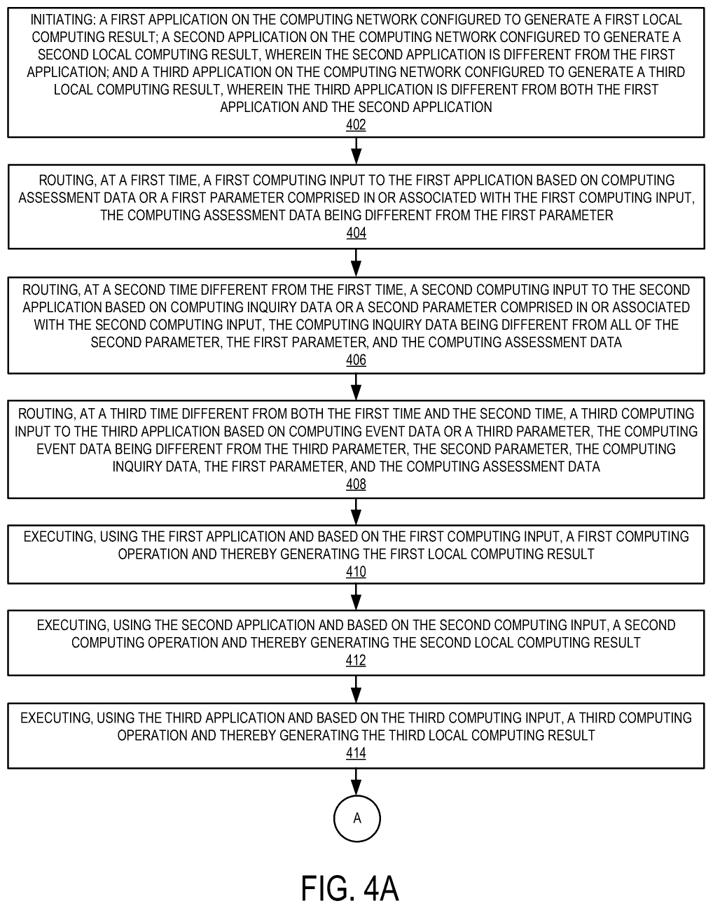

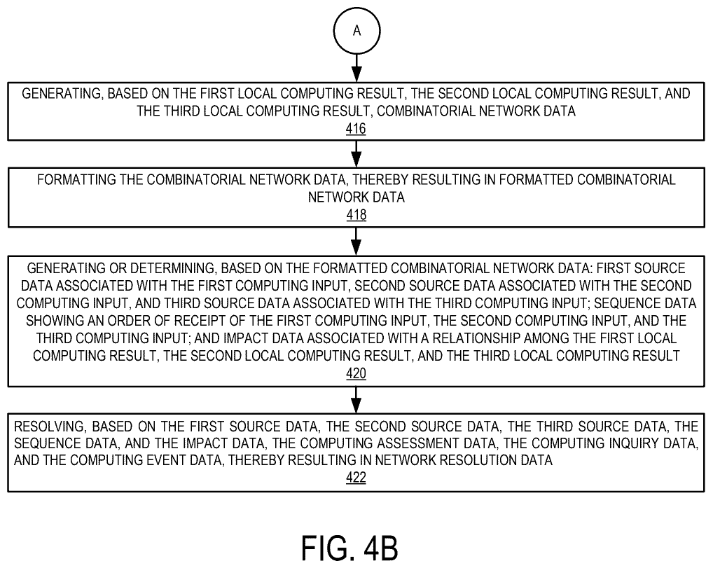

The system memory 222 may also include a data engine 140 or one or more data engines 140 stored in the memory device 22 and which cause a computer processor to execute the various processing stages of FIGS. 4A and 4B as further discussed below. For example, the flowchart of FIGS. 4A and 4B may be executed using the data engine 140 or a data processing module (e.g., computing module) stored in memory 222 such that the data engine 140 includes instructions that are executed by one or more processing units 221 to implement at least the flowchart of FIGS. 4A and 4B.

### Exemplary Embodiments

According to one embodiment, the disclosed solution comprises a mechanism or a framework associated with a secure storage network 100. The mechanism or framework can connect or otherwise link input data to one or more applications and/or combine a plurality of output data derived from two or more applications associated with the secure storage network 200 to determine data relationships that beneficially facilitate generation of insight data for resolving issues surrounding, for example: data queries or data inputs to the secure storage network; and/or identified data events associated with the one or more data queries or data inputs; and/or resolution data associated with the one or more data queries or data inputs.

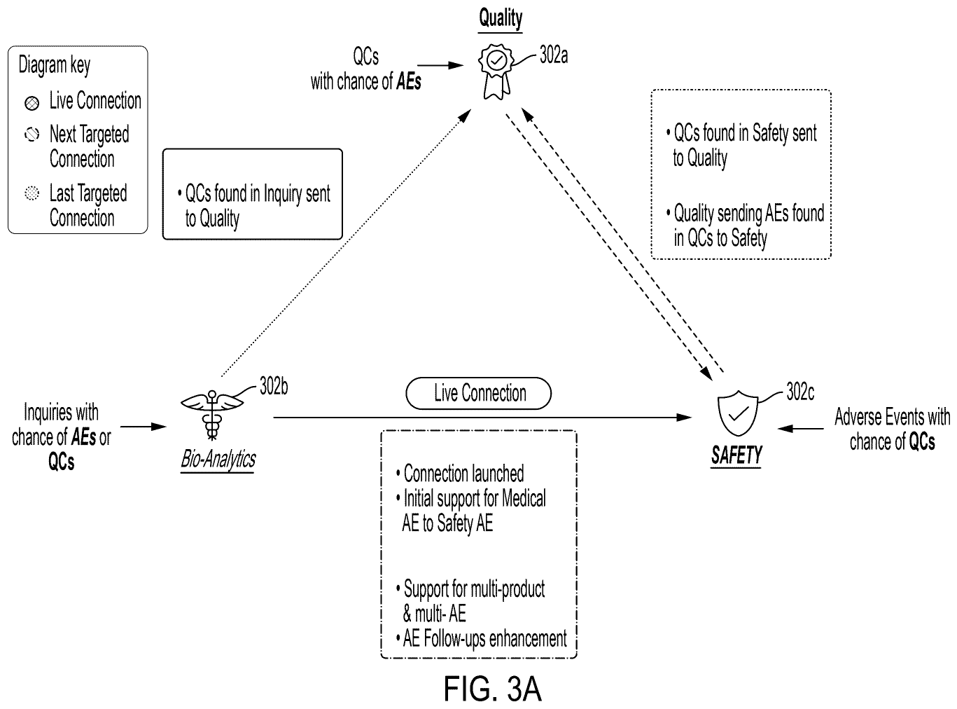

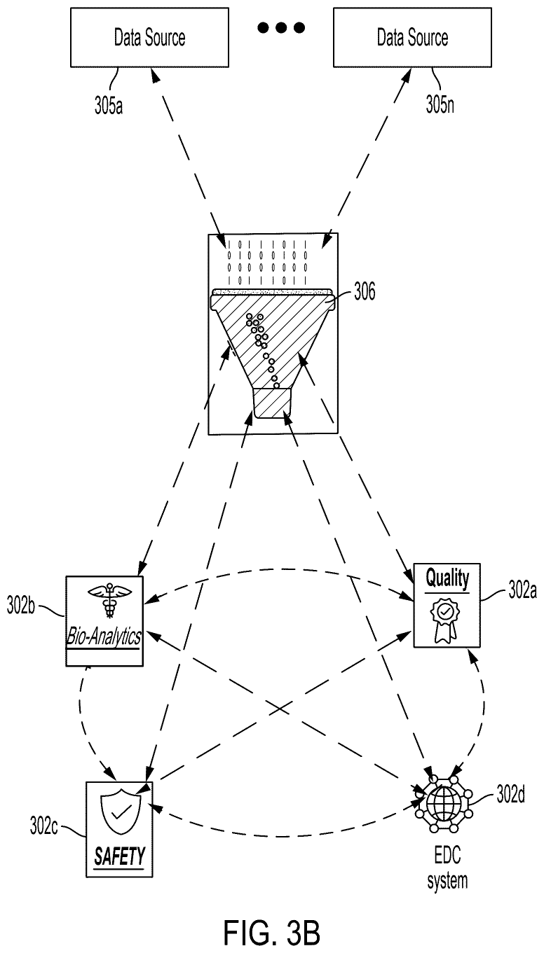

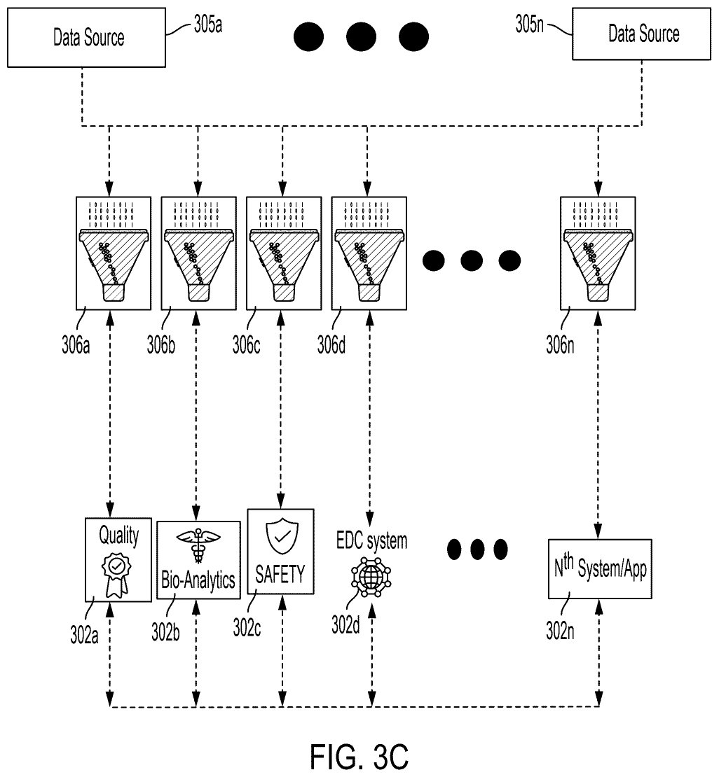

According to some embodiments, the disclosed secure storage network 100 is comprised in a cloud content management platform. The cloud content management platform, for example, can host a suite of data management and/or data analysis applications including: a data safety application associated with the secure storage network 100; an electronic data capture (EDC) application associated with the secure storage network 100; a data quality application associated with the secure storage network 100; and a data inquiries application associated with the secure storage network 100. Each of these applications is discussed in association with FIGS. 3A and 3B.

### Data Interconnections

The secure storage network 100 of FIG. 1A can be beneficially used to implement an interconnection of applications as shown in FIGS. 3A and 3B. In particular, the secure storage network 100 of FIG. 1A may comprise a cloud-based or non-cloud-based content management platform including a suite applications that provide research institutions, educational institutions, government institutions, medical institutions, social institutions, agricultural institutions, etc., with at least one source of truth data storage system that minimizes data and/or system complexities and enhances increased agility in communicating data between two or more applications comprised in the suite of applications. Moreover, the secure storage network 100 of FIG. 1A may be configured to manage secure or regulated documents or records indicating a configurable data object in addition to tracking critical information associated with the configurable data object and/or developing or enhancing parameters or data properties associated with the configurable data object. According to one embodiment, the configurable data object comprises a digital model, a systematized data construct of an object, or a digitized characterization of the object (e.g., real or otherwise) associated with a research, a trial, or a bio-inquiry process.

It is appreciated that the secure storage network 100 of FIG. 1A can globally connect a plurality of user systems across multiple similar or dissimilar jurisdictions or locations. Specifically, the secure storage network 100 of FIG. 1A can advantageously promote and streamline data collaboration among a plurality of user systems as well as quickly provide secure access to data being stored in the secure storage network 100. According to one embodiment, the secure storage network 100 of FIG. 1A may be used to regulate and/or monitor data states of content being stored within the secure storage network 100. This may include leveraging a real-time electronic dashboard of the secure storage network 100 to visualize and/or adaptively manipulate the data states as the case may require. The secure storage network 100 may also beneficially enable coordination among compliance systems that may or may not be integrated into the secure storage network 100.

It is further appreciated that the secure storage network of FIG. 1A may have an attendant interconnection of a plurality of applications (e.g., computing applications or computing software) that are configured to receive and/or process data inputs. For example, the plurality of applications may aggregate and/or clean the plurality of data inputs. Furthermore, one or more of the applications may include logic that aggregate and/or clean data elements comprised in the plurality of data inputs. In particular, each application of the plurality of applications may have at least one of the following features:
An electronic data capture feature adapted for designing and building electronic forms associated with the secure storage network 100.
A data transformation feature that can transform data inputs from a plurality of sources from a first data state to a second data state or from a third data state to a fourth data state, etc.
A questionnaire intake feature for receiving user inputs from diverse user computing systems.
A measurement capture feature for intaking a plurality of measurements from a plurality of sensors and/or other electronic or nonelectronic measuring devices that may or may not capture biological data.
A trial data intake feature for aggregating and/or controlling trial data associated with an experiment or a research.
A regulated content management feature adapted for approving, storing, and distributing content data (e.g., research content data, scientific content data, biological content data, biomedical content data, request content data, etc.).

FIG. 3A shows a first exemplary interconnection of a plurality of applications associated with the secure storage network 100 of FIG. 1A. In this figure, a first application 302a of the secure storage network 100 is configured to generate a first computing output (e.g., a first local computing result) which may or may not be related to a second computing output (e.g., a second local computing result) generated by a second application 302b of the secure storage network 100. Both of the first computing output and the second computing output may be independently related or combinatorially (e.g., in combination) related to a third computing output (e.g., a third local computing result) associated with, or generated by, a third application 302c of the secure storage network.

According to one embodiment, the first application 302a comprises logic configured to computationally implement an assessment computing operation that monitors, regulates, or transmits deviation data (e.g., quality control data or quality complaint (QC) data) associated with a first record or a second record indicating a configurable data object of the secure storage network 100. It is appreciated that quality control data or quality complaint data can comprise file or report data that indicates an issue associated with a configurable data object. According to one embodiment, the quality control data or quality complaint data may be derived from electronic and/or nonelectronic data sources. In one embodiment, the quality control or quality complaint data indicates an alleged deficiency associated with a configurable data object including: identifier deficiency data, quality deficiency data, durability deficiency data, reliability deficiency data, safety deficiency data, effectiveness deficiency data, or performance deficiency data. According to one embodiment, the quality control data or quality complaint data may include code information associated with the configurable data object, strength data associated with the configurable data object, application (e.g., useability) data associated with the configurable data object, type data associated with the configurable data object, problem summary data associated with the configurable data object, temporal (e.g., dates, times, etc.) data associated with the configurable data object, and/or image or video data indicating one or more defects associated with the configurable data object.

Similarly, the second application 302b may comprise logic configured to computationally implement inquiry computing operations including parsing and/or analyzing data requests (e.g., data elements comprised in an inquiry) associated with a first computing input, a second computing input, or a third computing input received by the secure storage network. It is appreciated that inquiries referenced in association with the second application 302b may be associated with bio-analytics or bio-response data processing associated with a configurable data object.

In addition, the third application 302c can include logic for adapted for processing event data (e.g., adverse event data) associated with a configurable data object. In particular, the third application 302c may be configured to have an event processing logic that analyzes a first computing input, a second computing input, or a third computing input and thereby determine a first detected event (e.g., adverse event (AE)), a second detected event, or a third detected event, respectively. According to one embodiment, an AE comprises a reported or nonreported unfavorable and/or unintended sign, condition, or indication that may be associated with the configurable data object during an experiment, a trial, or a study. The AE may be comprised in a file (e.g., an XML file) that may be processed by an application (e.g., third application 302c) of the secure storage network 100 to foster tracking and/or monitoring of the AE.

FIG. 3B shows an application interconnection implementation where an electronic data capture (EDC) application 302d is communicatively coupled to the first application 302a, the second application 302b, and the third application 302c. According to one embodiment, the EDC application 302d may be configured to generate fourth output data that can be related to, or correlated with data outputs associated with the first application 302a, the second application 302b, and/or the third application 302c. According to one embodiment, the EDC application may be configured to generate outputs including a first record, a second record, or a third record as the case may require, associated with a configurable data object.

Also shown in FIG. 3B is a plurality of data sources 305a . . . 305n from which the data analyzed or processed by the plurality of applications 302a . . . 302d originates. According to one embodiment, the plurality of data sources 305a . . . 305n may comprise electronic or non-electronic data sources from which is derived input data associated with a configurable data object. For example, the plurality of data sources may comprise telephonic or nontelephonic data sources, internet or non-internet data sources, web or non-web data sources, textual or non-textual data sources, audio or nonaudio data sources, video or nonvideo data sources, etc. According to one embodiment, the plurality of data sources comprise data sources associated with a research, a study, an experiment, etc. In other implementations, the one or more data sources may have corresponding communication channels including: a telephonic communication channel; a web application communication channel; an email communication channel; a video communication channel; a mobile messaging communication channel; a social media communication channel; or a secure communication channel associated with the secure storage network.

It is appreciated that the data from the plurality of data sources may be received by a centralized intake mechanism or data engine 306 that is configured to transform the data from the plurality of data sources from a first data state to a second data state. These data transformations, according to one embodiment, enables at least one application of the secure storage network 100 to ingest or otherwise receive and meaningfully process data from the data sources.

While four applications are shown in conjunction with FIG. 3B, it is appreciated that the secure storage network 100 may include a plurality of applications that are similar to, or distinct from the applications 302a . . . 302d such that the data engine 306 is able to: coordinate data transmissions to and from each application of the secure storage network 100; relate data outputs (e.g., local computing results) from multiple different applications to generate combinatorial network data; format the combinatorial network data to generate formatted combinatorial network data and thereby result in network resolution data for resolving and/or addressing: identified data flags or data issues; or AEs or QCs; etc. associated with a configurable data object. In particular, the network resolution data beneficially provides a digital representation or construct (e.g., report, a file, or a document) indicating strategies that holistically “look at” the configurable data object from the perspective of output data generated from one or more applications of the secure storage network 100 to determine effective strategies for resolving issues surrounding the configurable data object.

According to some embodiments, the data engine 306 comprises a plurality of data engines 306a . . . 306n, each of which corresponds to a data intake system and/or a data processing system configured for a specific application or system 302 comprised in the plurality of applications 302a . . . 302n of the secure storage network 100 as indicated in FIG. 3C. In particular, FIG. 3C shows an implementation where each of the plurality of applications 302a . . . 302n of the secure storage network 100 has its own dependent or independent data engine 306 comprised in the plurality of data engines 306a . . . 306n. In exemplary implementations, each data engine 306 comprised in the plurality of data engines 306a . . . 306n can: coordinate data transmissions to and from a corresponding application 302 comprised in the plurality of applications 302a . . . 302n; work independently or in aggregate to relate data outputs (e.g., local computing results) from multiple different applications 302 comprised in the plurality of applications 302a . . . 302n to generate combinatorial network data; and work independently or in aggregate to format the combinatorial network data and thereby generate formatted combinatorial network data as further discussed below. It is appreciated that the computing architecture of FIG. 3C beneficially enables containerizing and/or isolating and/or separating computing operations of each application 302 comprised in the plurality of applications 302a . . . 302n in cases where users leverage subsets of the plurality of applications 302a . . . 302n but not every one of the plurality of applications 302a . . . 302n. Furthermore, the architecture of FIG. 3C advantageously enables computing operation speed-ups (e.g., quickly generating combinatorial network data) based on user preferences (e.g., users selecting a subset of the plurality of applications 302a . . . 302n and not the entirety of the plurality of applications 302a . . . 302n) and/or project preferences associated with determining and/or generating combinatorial network data.

In some implementations, the disclosed secure storage network 100 of FIG. 1A comprises a data messenger framework that provides data integrations and/or data communications between the aforementioned plurality of applications of the secure storage network 100. For instance, at least one of a data management and/or data analysis application of the secure storage network 100 can enable delivery of data queries or input data (e.g., safety data) from, for example, one or more of data partner systems and/or client applications to one or more systems or applications of the secure storage network 100. In some cases, connecting or linking input data or data queries to one or more applications or systems of the secure storage network 100 can be based on: specific data types comprised in the input data or data queries; usage designation data comprised in the input data or data queries; request type data comprised in the input data or data queries; and/or identifier data comprised in the input data or data queries to the secure storage network 100. In an exemplary implementation, a data messenger application (e.g., a Spark messenger application) may be used to transfer and/or receive data between one or more applications associated with the secure storage network 100.

According to one embodiment, the disclosed technology can be used to establish data relationships and/or connect or link: a safety application associated with the secure storage network with an EDC application associated with the secure storage network; the safety application associated with the secure storage system with a bio-application/bio-analytics application associated with the secure storage network; the bio-application/bio-analytics application associated with the secure storage network with a QC application associated with the secure storage network; and the safety application associated with the secure storage network with the quality control application associated with the secure storage network.

### Exemplary Flowchart

FIGS. 4A and 4B show an exemplary workflow for routing a computing input within a computing network and generating network resolution data. It is appreciated that one or more data engines stored in a memory device may cause a computer processor to execute the various processing stages of the workflow of FIGS. 4A and 4B. For example, the disclosed techniques may be implemented as one or more data engines comprised in a secure storage network (e.g., computing network) that has a plurality of applications, each of which may be configured to generate computing outputs (e.g., local computing results) in response to processing or analyzing one or more computing inputs.

At block 402, the one or more data engines may be used to initiate: a first application on the computing network configured to generate a first local computing result; a second application on the computing network configured to generate a second local computing result, wherein the second application is different from the first application; and a third application on the computing network configured to generate a third local computing result, wherein the third application is different from both the first application and the second application.

The one or more data engines may be further used, at block 406, to rout, at a first time, a first computing input to the first application based on computing assessment data or a first parameter comprised in or associated with the first computing input, the computing assessment data being different from the first parameter. For example, the computing assessment data may comprise quantitative and/or qualitative data associated with a configurable data object such that the quantitative and/or qualitative data are transformed into, a record type indicating the first parameter.

Furthermore, the one or more data engines may also rout, at a second time different from the first time, a second computing input to the second application based on computing inquiry data or a second parameter comprised in or associated with the second computing input, the computing inquiry data being different from all of the second parameter, the first parameter, and the computing assessment data. It is appreciated that the computing inquiry data may comprise a plurality of identifier data and/or quantitative data and/or qualitative data associated with the configurable data object. In particular, the second parameter may depend on the computing assessment data but not the other way round, according to some embodiments.

Moreover, the one or more data engines may further rout, at a third time different from both the first time and the second time, a third computing input to the third application based on computing event data or a third parameter, the computing event data being different from the third parameter, the second parameter, the computing inquiry data, the first parameter, and the computing assessment data. It is appreciated that the computing event data may include adverse event data associated with the configurable data object such that the adverse event data may have a plurality of data characteristics that are broadly consolidated into an identifier or a record information indicating the third parameter. In addition, the first time, the second time, and the third time referenced above indicate implementations where the routing of the first computing input, the second computing input, and the third computing input are asynchronously routed to various applications of the computing network or the secure storage network 100 referenced above. In other embodiments, the first time, the second time, and the third time are all the same time such that the first computing input, the second computing input, and the third computing input are synchronously routed to the first application, the second application, and the third application, respectively. This synchronous or asynchronous aspects of the secure storage network 100 emphasize the adaptive nature of routing data inputs to respective applications.

At block 410, the one or more data engines may be implemented to execute, using the first application and based on the first computing input, a first computing operation and thereby generating the first local computing result. The one or more data engines may also be implemented, at block 412, to execute, using the second application and based on the second computing input, a second computing operation and thereby generating the second local computing result. Similarly, the one or more data engines may be implemented, at block 414, to execute, using the third application and based on the third computing input, a third computing operation and thereby generating the third local computing result.

Turning to block 416 of FIG. 4B, the one or more data engines may be used to generate, based on the first local computing result, the second local computing result, and the third local computing result, combinatorial network data following which the one or more data engines may be further used to format, at block 418, the combinatorial network data, thereby resulting in formatted combinatorial network data.

At block 420, the one or more data engines may be used to generate or determine, based on the formatted combinatorial network data, first source data associated with the first computing input, second source data associated with the second computing input, and third source data associated with the third computing input. The first source data, the second source data, and the third source data beneficially enable tracing issues and/or flagged problems to specific data points of origin and/or to specific causes which can be holistically looked at to determine optimal ways to mitigate or otherwise manage said issues or problems.

In addition, the one or more data engines may be used to generate or determine, based on the formatted combinatorial network data, sequence data showing an order of receipt of the first computing input, the second computing input, and the third computing input. This receipt sequencing or order sequencing of inputs to the computing network enables establishing timelines of event occurrences and thereby determine, for example, frequency data indicating patterns or instances with a regularity of event occurrences (e.g., adverse event occurrences, inquiry event occurrences, safety event occurrences, etc.) associated with the configurable data object.

Moreover, the one or more data engines may be used to generate or determine, based on the formatted combinatorial network data, impact data associated with a relationship among the first local computing result, the second local computing result, and the third local computing result.

At block 422, the one or more data engines may be used to resolve, based on the first source data, and/or the second source data, and/or the third source data, and/or the sequence data, and/or the impact data, and/or the computing assessment data, and/or the computing inquiry data, and/or the computing event data, thereby resulting in the generation of network resolution data. In other words, generating the network resolution data may comprise resolving, based on the first source data, the second source data, the third source data, the sequence data, and the impact data, one or more of the computing assessment data, the computing inquiry data, and the computing event data and thereby generate the network resolution data. According to one embodiment, the network resolution data provides a comprehensive, global, or holistic data used to inform a strategy for resolving a detected event or issue surrounding a configurable data object based on the computing assessment data, and/or the computing inquiry data, and/or the computing event data.

It is appreciated that the network resolution data may comprise a report, a file, a document, or a digital record indicating textual and/or image data that may or may not comprise a multi-dimensional visualization with strategies for managing and/or resolving issues surrounding a configurable data object associated with the computing network.

In some embodiments, a system and a computer program product can include or execute the method described in association with FIGS. 4A and 4B. These and other implementations may each optionally include one or more of the following features.

The first computing input or the second computing input may be derived from at least one communication channel comprising at least one of: a telephonic communication channel; a web application communication channel; an email communication channel; a video communication channel; a mobile messaging communication channel; a social media communication channel; or a secure communication channel associated with the secure storage network.

In some embodiments, an electronic confirmation is transmitted to a first computing device via a first one of the at least one communication channel. Furthermore, the network resolution data may also be transmitted to a second computing device via one of the at least one communication channel.

According to some embodiments, the first computing device is associated with a first geographical location and the second computing device is associated with a second geographical location.

It is appreciated that the first application or the second application or the third application comprises one of: an assessment computing application configured to monitor, regulate, or transmit deviation data associated with a first record (e.g., a record associated a configurable data object) or a second record (e.g., a record associated a configurable data object); an inquiries computing application configured to parse or analyze data requests associated with the first computing input, the second computing input, or the third computing input; an event processing computing application configured to analyze the first computing input, the second computing input, or the third computing input to determine a first detected event, a second detected event, or a third detected event, respectively; and an electronic data capture (EDC) application configured to generate the first record, the second record, or a third record.

In some implementations, one of a third computing input or a fourth computing input is simultaneously routed to two or more distinct applications of the network. In addition, the two or more distinct applications are configured to execute multiple computing operations on one of the third computing input or the fourth computing input.

According to one embodiment, one or more of the first computing input or the second computing input is digitally converted or transformed into a first record or a second record, respectively, prior to executing the first computing operation or the second computing operation, respectively. Moreover, a script or a configurable web form may be used for transforming the first computing input or the second computing input into the first record or the second record, respectively.

In some cases, the workflow depicted in FIGS. 4A and 4B further comprise linking, using the one or more data engines, first event data associated with the first computing input to second event data associated with the second computing input. The one or more data engines may be further used to generate the network resolution data based on events (e.g., event data) detected in at least one of the first computing input, the second computing input, or the third computing input. According to one embodiment, a first detected event comprised in the events detected indicates a defect associated with a configurable data object while a second detected event comprised in the detected events indicates outcome data associated with the defect associated with configurable data object.

It is appreciated that the computing network referenced above can comprise a secure storage network. It is further appreciated that the formatted combinatorial network data indicates a global computing output for the secure storage network. Moreover, the global computing output can comprise data elements associated with the first local computing result, the second local computing result, and the third local computing result. In addition, the global computing output can provide a holistic indication of a detected or logged event associated with the secure storage network with attendant strategies for mitigating the detected or logged event.

According to some embodiments, the relationship among the first local computing result, the second local computing result, and the third local computing result comprises one of: a causal relationship among the first local computing result, the second local computing result, and the third local computing result; or a dependence relationship among the first local computing result, the second local computing result, and the third local computing result. In one embodiment, the causal relationship indicates a cause-and-effect relationship where one event comprised in event data associated with the first computing result directly links or results in another event comprised in event data associated with the second computing result and/or the third computing result. In other embodiments, the dependence relationship indicates data instances where event data associated with the first computing result, for example, depends (e.g., symbiotically depends) on event data associated with the second computing result and/or the third computing result.

According to some embodiments, each application (e.g., see applications 302a . . . 302n in FIGS. 3A-3C) can be configured to contextualize event data detected in at least the first computing input, the second computing input, the third computing input, or other computing inputs received by the one or more data engines of the secure storage network from the perspective of multiple applications of the secure storage network. In other words, the first computing result, the second computing result, and the third computing result can each indicate multiple data perspectives of similar or dissimilar detected event data such that the first computing result, the second computing result, and the third computing result include context data or impact assessment data indicating the multiple data perspectives of the similar or dissimilar detected event data. In some cases, context data or impact assessment data comprised in the first computing result, the second computing result, the third computing result, a fourth computing result from a fourth application, etc., beneficially enable linking and/or connecting, and/or correlating, and/or relating the various computing results, generated by the applications of the secure storage network, with each other and thereby generate the combinatorial network data.

According to one embodiment, the first application comprises an assessment computing application associated with a first data repository of the secure storage network such that the first data repository stores first impact assessment data associated with the first computing result. Furthermore, the second application can comprise an assessment computing application associated with a second data repository of the secure storage network such that the second data repository stores second impact assessment data associated with the second computing result. In addition, the third application can comprise an inquiry computing application associated with a third data repository of the secure storage network such that the third data repository stores third impact assessment data associated with the third computing result. It is appreciated that the first computing result, the second computing result, and the third computing result, respectively, can comprise the first impact assessment data, the second impact assessment data, and the third impact assessment data. It is further appreciated that the first impact assessment data, the second impact assessment data, and the third impact assessment data can be related or otherwise linked, based on integration point configuration data associated with the first repository, the second repository, and the third repository, to generate the combinatorial network data. In some cases, the integration point configuration data beneficially enables data communication (e.g., integration point message communications) between the first repository, the second repository, and the third repository before, during, or after the linking of the first impact assessment data, the second impact assessment data, and the third impact assessment data.

In some embodiments, resolving, based on the first source data, the second source data, the third source data, the sequence data, and the impact data, the computing assessment data, the computing inquiry data, and the computing event data, comprises: analyzing data elements comprised in the first source data, the second source data, the third source data, the sequence data, and the impact data, to determine one or more record links between the first source data, the second source data, the third source data, the sequence data, and the impact data; establishing, based on the one or more record links, one or more electronic connections between the data elements comprised in the first source data, the second source data, the third source data, the sequence data, and the impact data; and generating, based on the one or more electronic connections, the network resolution data.

It is appreciated that the first computing operation can be associated with a control event while the second computing operation is associated with a bioreaction event. It is further appreciated that the third computing operation can be associated with a diagnostic event.

According to one embodiment, the combinatorial network data is generated by selectively merging or combining data elements comprised in the first local computing result, the second local computing result, and the third local computing result.

In some cases, the first parameter comprises a first record type associated with the computing assessment data while the second parameter comprises a second record type associated with the computing inquiry data. It is appreciated that the third parameter can comprise a third record type associated with the computing event data.

According to one embodiment, the computing assessment data indicates a first log of an assessment of a configurable data object while the computing inquiry data indicates a second log of an inquiry associated with applying or using the configurable data object. It is appreciated that the computing event data can indicate a third log of an adverse event associated with applying or using the configurable data object.

According to some embodiments, the combinatorial network data includes a first field or a first data characterization parameter for storing or indicating the first computing result. Similarly, the combinatorial network data may include a second field or a second data characterization parameter for storing or indicating the second computing result such that the first field or first data characterization parameter is different from the second field or the second data characterization parameter. Furthermore, the combinatorial network data can include a third field or a third data characterization parameter for storing or indicating the third computing result. It is appreciated that the third field or third data characterization parameter is different from both the first and second fields. It is further appreciated that the combinatorial network data may further include a fourth, a fifth, a sixth, or an “n^{th}” field or an “n^{th}” data characterization parameter associated with more than 3 or more than 4 or more than 5 computing results generated from a plurality of applications comprised in the secure storage network.” In some embodiments, the combinatorial network data comprises a computing model that is parameterized based on one or more of the first computing result, the second computing result, the third computing result, a fourth computing result, etc. In particular, the combinatorial network data can comprise a plurality of different parameters each of which are distinct from each other such that each one of the plurality of different parameters indicate a computing result generated by a corresponding application comprised in the plurality of different applications of the secure storage network.

According to one embodiment, formatting the combinatorial network data to generate the formatted combinatorial network data comprises one or more of: customizing the combinatorial network data for display on a graphical display device based on device type data (e.g., desktop device data, mobile phone device data, tablet device data, etc.) associated with the graphical display device; dynamically adjusting multidimensional visualizations (e.g., 2-dimensional visualizations or 3-dimensional visualizations) indicating the combinatorial network data for display on the graphical display device; automatically preparing a data package including the combinatorial network data for transmission to stakeholder computing systems and/or to other applications of the secure storage network; adaptively eliminating data redundancies within the combinatorial network data based on one or more of the first computing result, the second computing result, the third computing result, etc.; labelling one or more of the first source data, the second source data, the third source data, the sequence data, the impact data, and other data elements comprised in the combinatorial network data to have corresponding identifiers prior to displaying the combinatorial network data on the graphical display device; and executing one or more analysis operations on the combinatorial network data to generate tiered or non-tiered data categories that establish data dependencies between a plurality of computing results (e.g., first computing result, second computing result, third computing result, etc.) with attendant quantification of the various degrees to which the plurality of computing results are related.

The above-described features and applications can be implemented as software processes or data engines include specified sets of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

These functions described above can be implemented in digital electronic circuitry, in computer software, firmware, or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

In this specification, the term “application” or “software” is meant to include firmware residing in read-only memory or applications stored in magnetic storage, which can be read into memory for processing by a processor. Also, in some implementations, multiple software or application technologies can be implemented as sub-parts of a larger program while remaining distinct software technologies. In some implementations, multiple software technologies can also be implemented as separate programs. Finally, any combination of separate programs that together implement a software technology described here is within the scope of the subject technology. In some implementations, the software programs, when installed to operate on one or more electronic systems, define one or more specific machine implementations that execute and perform the operations of the software programs. Examples of computer programs or computer code include machine code, for example is produced by a compiler, and files including higher-level code that are executed by a computer, an electronic component, or a microprocessor using an interpreter.

A computer program (also known as a program, software, software application, application, script, or code) can be written in any form of programming language, including compiled or interpreted languages, declarative or procedural languages, and it can be deployed in any form, including as a standalone program or as a sub-system, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more sub-systems, sub programs, or portions of code). A computer program can be deployed to be executed on one computer or on multiple computers that are located at one site or distributed across multiple sites and interconnected by a communication network.

As used in this specification and any claims of this application, the terms “computer,” “server,” “processor,” and “memory” all refer to electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

It is understood that any specific order or hierarchy of steps in the processes disclosed is an illustration of example approaches. Based upon design preferences, it is understood that the specific order or hierarchy of steps in the processes may be rearranged, or that all illustrated steps be performed. Some of the steps may be performed simultaneously. For example, in certain circumstances, multitasking and parallel processing may be advantageous. Moreover, the separation of various system components illustrated above should not be understood as requiring such separation, and it should be understood that the described program components and systems can generally be integrated together in a single software product or packaged into multiple software products.

Various modifications to these aspects will be readily apparent, and the generic principles defined herein may be applied to other aspects. Thus, the claims are not intended to be limited to the aspects shown herein, but is to be accorded the full scope consistent with the language claims, where reference to an element in the singular is not intended to mean “one and only one” unless specifically so stated, but rather “one or more.” Unless specifically stated otherwise, the term “some” refers to one or more.

Various terms used herein have meanings within the present technical field. Whether a particular term should be construed as such a “term of art,” depends on the context in which that term is used. “Connected to,” “in communication with,” or other similar terms should generally be construed broadly to include situations both where communications and connections are direct between referenced elements or through one or more intermediaries between the referenced elements, including through the Internet or some other communicating network. “Network,” “system,” “environment,” and other similar terms generally refer to networked computing systems that embody one or more aspects of the present disclosure. These and other terms are to be construed in light of the context in which they are used in the present disclosure and as those terms would be understood by one of ordinary skill in the art would understand those terms in the disclosed context. The above definitions are not exclusive of other meanings that might be imparted to those terms based on the disclosed context.

Words of comparison, measurement, and timing such as “at the time,” “equivalent,” “during,” “complete,” and the like should be understood to mean “substantially at the time,” “substantially equivalent,” “substantially during,” “substantially complete,” etc., where “substantially” means that such comparisons, measurements, and timings are practicable to accomplish the implicitly or expressly stated desired result.

It is appreciated that the term optimize/optimal and its variants (e.g., efficient or optimally) may simply indicate improving, rather than the ultimate form of ‘perfection’ or the like.

It is further appreciated that any portion or element of any embodiment (structure, method, etc.) disclosed herein may be combined with any portion or element of any other embodiment (structure, method, etc.) disclosed herein.

Additionally, the section headings herein are provided for consistency with the suggestions under 37 CFR 1.77 or otherwise to provide organizational cues. These headings shall not limit or characterize the disclosed embodiment(s) set out in any claims that may issue from this disclosure. Specifically, and by way of example, although the headings refer to a “Technical Field,” such claims should not be limited by the language chosen under this heading to describe the so-called technical field. Further, a description of a technology in the “Background” is not to be construed as an admission that technology is prior art to any disclosed embodiment(s) in this disclosure. Neither is the “Summary” to be considered as a characterization of the disclosed embodiment(s) set forth in issued claims. Furthermore, any reference in this disclosure to “embodiment” in the singular should not be used to argue that there is only a single point of novelty in this disclosure. Multiple embodiments may be set forth according to the limitations of the multiple claims issuing from this disclosure, and such claims accordingly define the disclosed embodiment(s), and their equivalents, which are protected thereby. In all instances, the scope of such claims shall be considered on their own merits in light of this disclosure, but should not be constrained by the headings set forth herein.

1. A method for routing a computing input within a computing network and generating network resolution data, the method comprising:
initiating, using one or more computing device processors:
a first application on the computing network configured to generate a first computing result,
a second application on the computing network configured to generate a second computing result, wherein the second application is different from the first application, and
a third application on the computing network configured to generate a third computing result, wherein the third application is different from both the first application and the second application;
routing, using the one or more computing device processors, at a first time, a first computing input to the first application based on computing assessment data or a first parameter comprised in the first computing input, the computing assessment data being different from the first parameter;
routing, using the one or more computing device processors, at a second time different from the first time, a second computing input to the second application based on computing inquiry data or a second parameter comprised in the second computing input, the computing inquiry data being different from the second parameter, the first parameter, and the computing assessment data;
routing, using the one or more computing device processors, at a third time different from both the first time and the second time, a third computing input to the third application based on computing event data or a third parameter comprised in the third computing input, the computing event data being different from the third parameter, the second parameter, the computing inquiry data, the first parameter, and the computing assessment data;
executing, using the one or more computing device processors and the first application, based on the first computing input, a first computing operation and thereby generating the first computing result;
executing, using the one or more computing device processors and the second application, based on the second computing input, a second computing operation and thereby generating the second computing result;
executing, using the one or more computing device processors and the third application, based on the third computing input, a third computing operation and thereby generating the third computing result;
generating, using the one or more computing device processors, based on the first computing result, the second computing result, and the third computing result, combinatorial network data;
formatting, using the one or more computing devise processors, the combinatorial network data, thereby resulting in formatted combinatorial network data;
generating or determining, using the one or more computing devise processors, based on the formatted combinatorial network data:
first source data associated with the first computing input,
second source data associated with the second computing input,
third source data associated with the third computing input,
sequence data showing an order of receipt of the first computing input, the second computing input, and the third computing input, and
impact data associated with a relationship among the first computing result, the second computing result, and the third computing result; and
generating, using the one or more computing devise processors and based on the first source data, the second source data, the third source data, the sequence data, and the impact data, network resolution data.

2. The method of claim 1, wherein the first application, the second application or the third application comprises at least one of:
an assessment computing application configured to monitor, regulate, or transmit deviation data associated with a first record or a second record;
an inquiry computing application configured to parse or analyze data requests associated with the first computing input, the second computing input, or the third computing input;
an event processing computing application configured to analyze the first computing input, the second computing input, or the third computing input to determine a first detected event, a second detected event, or a third detected event, respectively; and
an electronic data capture (EDC) application configured to generate the first record, the second record, or a third record.

3. The method of claim 1, wherein:
one of the third computing input or a fourth computing input is simultaneously routed to two or more distinct applications of the computing network; and
the two or more distinct applications are configured to execute multiple computing operations on one of the third computing input or the fourth computing input.

4. The method of claim 1, wherein:
one or more of the first computing input or the second computing input is converted or transformed into a first record or a second record, respectively, prior to executing the first computing operation or the second computing operation, respectively; and
a script or a configurable web form is used for transforming the first computing input or the second computing input into the first record or the second record, respectively.

5. The method of claim 1, further comprising linking first event data associated with the first computing input to second event data associated with the second computing input.

6. The method of claim 1, further comprising generating the network resolution data based on event data detected in at least one of the first computing input, the second computing input, or the third computing input.

7. The method of claim 6, wherein:
a first detected event comprised in the event data detected indicates a defect associated with a configurable data object; and
a second detected event comprised in the event data indicates outcome data associated with the configurable data object.

8. The method of claim 1, wherein the computing network comprises a secure storage network.

9. The method of claim 8, wherein:
the formatted combinatorial network data indicates a global computing output for the secure storage network;
the global computing output comprising data elements associated with the first computing result, the second computing result, and the third computing result;
the global computing output providing an indication of a detected or logged event associated with the secure storage network.

10. The method of claim 1, wherein the relationship comprises one of:
a causal relationship among the first computing result, the second computing result, and the third computing result; or
a dependence relationship among the first computing result, the second computing result, and the third computing result.

11. The method of claim 1, wherein resolving, based on the first source data, the second source data, the third source data, the sequence data, and the impact data, the computing assessment data, the computing inquiry data, and the computing event data, comprises:
analyzing data elements comprised in the first source data, the second source data, the third source data, the sequence data, and the impact data, to determine one or more record links between the first source data, the second source data, the third source data, the sequence data, and the impact data; and
establishing, based on the one or more record links, one or more electronic connections between the data elements comprised in the first source data, the second source data, the third source data, the sequence data, and the impact data; and
generating, based on the one or more electronic connections, the network resolution data.

12. The method of claim 1, wherein:
the first computing operation is associated with a control event;
the second computing operation is associated with a bioreaction event; and
the third computing operation is associated with a diagnostic event.

13. The method of claim 1, wherein the first computing input or the second computing input is derived from at least one communication channel comprising at least one of:
a telephonic communication channel;
a web application communication channel;
an email communication channel;
a video communication channel;
a mobile messaging communication channel;
a social media communication channel; or
a secure communication channel associated with the secure storage network.

14. The method of claim 13, wherein:
an electronic confirmation is transmitted to a first computing device via the at least one communication channel; and
the network resolution data is transmitted to a second computing device via the at least one communication channel.

15. The method of claim 14, wherein the first computing device is associated with a first geographical location and the second computing device is associated with a second geographical location.

16. A system for routing a computing input within a computing network and generating network resolution data, the system comprising:
one or more hardware computing system processors; and
at least one memory storing instructions, that when executed by the one or more computing system processors causes the one or more computing system processors to:
initiate:
a first application on the computing network configured to generate a first computing result,
a second application on the computing network configured to generate a second computing result, wherein the second application is different from the first application, and
a third application on the computing network configured to generate a third computing result, wherein the third application is different from both the first application and the second application;
route, at a first time, a first computing input to the first application based on computing assessment data or a first parameter associated with the first computing input, the computing assessment data being different from the first parameter;
route, at a second time different from the first time, a second computing input to the second application based on computing inquiry data or a second parameter associated with the second computing input, the computing inquiry data being different from the second parameter, the first parameter, and the computing assessment data;
route, at a third time different from both the first time and the second time, a third computing input to the third application based on computing event data or a third parameter associated with the third computing input, the computing event data being different from the third parameter, the second parameter, the computing inquiry data, the first parameter, and the computing assessment data;
execute, using the first application and based on the first computing input, a first computing operation and thereby generating the first computing result;
execute, using the second application and based on the second computing input, a second computing operation and thereby generating the second computing result;
execute, using the third application and based on the third computing input, a third computing operation and thereby generating the third computing result;
generate, based on the first computing result, the second computing result, and the third computing result, combinatorial network data;
format the combinatorial network data, thereby resulting in formatted combinatorial network data;
generate or determine, based on the formatted combinatorial network data:
first source data associated with the first computing input,
second source data associated with the second computing input,
third source data associated with the third computing input,
sequence data showing an order of receipt of the first computing input, the second computing input, and the third computing input, and
impact data associated with a relationship among the first computing result,
the second computing result, and the third computing result; and
generating, based on the first source data, the second source data, the third source data, the sequence data, and the impact data, network resolution data.

17. The system of claim 16, wherein:
the first application comprises an assessment computing application associated with a first data repository of the secure storage network, the first data repository storing first impact assessment data associated with the first computing result;
the second application comprises an assessment computing application associated with a second data repository of the secure storage network, the second data repository storing second impact assessment data associated with the second computing result;
the third application comprises an inquiry computing application associated with a third data repository of the secure storage network, the third data repository storing third impact assessment data associated with the third computing result; and
the first computing result, the second computing result, and the third computing result, respectively, comprise the first impact assessment data, the second impact assessment data, and the third impact assessment data, wherein the first impact assessment data, the second impact assessment data, and the third impact assessment data are related or linked, based on integration point configuration data associated with the first repository, the second repository, and the third repository, to generate the combinatorial network data.

18. The system of claim 16, wherein:
the combinatorial network data is generated by selectively merging or combining data elements comprised in the first computing result, the second computing result, and the third computing result; and
generating the network resolution data comprises resolving, based on the first source data, the second source data, the third source data, the sequence data, and the impact data, one or more of the computing assessment data, the computing inquiry data, and the computing event data and thereby generate the network resolution data.

19. The system of claim 16, wherein:
the first parameter comprises a first record type associated with the computing assessment data;
the second parameter comprises a second record type associated with the computing inquiry data; and
the third parameter comprises a third record type associated with the computing event data.

20. The system of claim 16, wherein:
the computing assessment data indicates a first log of an assessment of a configurable data object;
the computing inquiry data indicates a second log of an inquiry associated with applying or using the configurable data object; and
the computing event data indicates a third log of an adverse event associated with applying or using the configurable data object.
